(19) United States
(12) Patent Application Publication
(10) Pub. No.: US 2013/0055122 A1
(43) Pub. Date: Feb. 28, 2013

(54) MACRO MANAGEMENT SYSTEM FORAN ENGINEERING SYSTEM FOR PARAMETERIZING SWITCHGEAR

(71) Applicant: Andre Turnaus, Heroldsberg (DE)

(72) Inventor: Andre Turnaus, Heroldsberg (DE)

(73) Assignee: SIEMENS AKTIENGESELLSCHAFT, Munich (DE)

(21) Appl. No.: 13/695,514

(22) PCT Filed: Apr. 13, 2011
(86) PCT No.: PCT/EP11/55748

§ 371 Date: Oct. 31, 2012

(30) Foreign Application Priority Data
May 3, 2010 (DE) 10 2010 019 142.6

(51) Int. Cl. G06F 3/048

(52) U.S. Cl. 715/764

(57) ABSTRACT

A macro management system is disclosed for an engineering system for parameterizing switchgear using core modules. In at least one embodiment, the macro management system has, as core modules, a creation module which is designed to create macros, a display/catalogue module which is designed to present all macros present in the system, an import module which is designed to integrate already existing macros into the system, and an export module which is designed to distribute macros which have already been created. The macro management system is connected to a graphical user interface of the engineering system, and the project engineer can be guided, with various options, to a restricted final selection of macros via a plurality of question levels.

### PRIORITY STATEMENT

This application is the national phase under 35 U.S.C. §371 of PCT International Application No. PCT/EP2011/055748 which has an International filing date of Apr. 13, 2011, which designated the United States of America, and which claims priority to German patent application number DE 10 2010 019 142.6 filed May 3, 2010, the entire contents of each of which are hereby incorporated herein by reference.

### FIELD

At least one embodiment of the invention generally relates to a macro management system for an engineering system for parameterizing switchgear.

### BACKGROUND

In the domain of industrial automation technology, control systems and field devices are utilized. Modern and complex field devices (for example, safety switchgear units, motor management systems) are characterized, inter alia, in that they possess a large number of parameters. By way of the parameters, field devices can be adapted to the actual usage conditions in the field (for example, current limit values, alarm thresholds, internal time components, internal counters, etc.). The device parameters are stipulated by the project engineer of the system with the aid of an engineering system and subsequently loaded onto the device. For this purpose, the project engineer usually has an engineering system available which enables dialogue-based parameterizing or graphical parameterizing. Control systems (for example, SPS, IPC, CNC) are capable of cyclically processing control programs created by the user. In this way, freely definable control functions can be assigned to the control system. Different possibilities for creating a control program are made available to the project engineer with the aid of an engineering system. The project engineer can, for example, draw upon classical SPS languages (e.g. KOP, FUP, AWL), high-level languages (e.g. SCL) and graphical programming using function plans (e.g. CFC—Continuous Function Charts). In the case of graphical programming, ready-made functional components are interconnected with one another in a plan. The plans are then interpreted by the engineering system in the control program and loaded onto the target system (CPU).

Low voltage switchgear (for example, motor starters, motor management systems or safety systems) is increasingly characterized by having a large number of device parameters and device functions. Complex switchgear is also capable of processing application logic (for instance safety programs), so that such devices can be flexibly adapted to the requirements in the field.

The parameterizing of said complex electronic switchgear takes place, as a rule, on the basis of an engineering system which makes available to the device both logic and also parameters. A modern engineering system also has a graphic user interface (GUI) which makes it easy for the project engineer to parameterize the relevant devices.

One aspect of the graphic user interface of the engineering system resides in making functions which the device offers selectable by the project engineer from within a function catalogue and interconnectable within a function plan. In a function plan of this type, the project engineer can connect functional components to one another and, by this, create a complete function logic system tailored to the particular case.

As the complexity of switchgear increases and as parameterizing capabilities grow, so the complexity and scope of the application logic to be created within the function plan increases. The effort involved in drawing up error-free function plans for a device or a complete plant without aids, that is, enhanced support from the engineering system, is increasing substantially. At the same time, the testing effort and the error probability increases substantially with the scale of the function logic.

In order to master the increasing complexity, the systematic re-use of previously created and tested function units suggests itself. However, this systematic re-use of previously created functions is frequently made more difficult by lacking or insufficient documentation for the partial solutions, a lack of actual technical help from the engineering system when partial solutions are used and the lack of help in the selection of partial solutions, in particular, where very similar partial solutions are available. The selection of an incorrect partial solution or the false use thereof is usually costly, since this often results in a re-design of the overall solution.

### SUMMARY

A macro management system is provided for an engineering system for parameterizing switchgear wherein a repertoire of pre-fabricated partial solutions is available to the project engineer of a system. The project engineer is able to use in a targeted and technically correct manner in order to reach the solution of an automation task in a short time-frame, in particular the parameterizing of the switchgear involved.

Advantageous embodiments and developments which can be used individually or in combination with one another are the subject matter of the dependent claims.

According to at least one embodiment of the invention, a macro management system for an engineering system for parameterizing switchgear, comprises at least the following core modules:
a creation module which is designed to create macros;
a display module which is designed for the presentation of all the macros present in the system;
an import module which is designed to integrate already existing macros into the system; and
an export module which is designed to distribute macros which have already been created,
   wherein the macro management system is connected to a graphical user interface of the engineering system and wherein the project engineer can be guided, with various options, to a restricted final selection of macros via a plurality of question levels.

A macro is a re-usable partial solution of a parameterizing process. An engineering system is a computer-based system for the conception of an automation solution, in this case in particular, for the parameterizing of switchgear.

### BRIEF DESCRIPTION OF THE DRAWINGS

Further advantages and embodiments of the invention will now be described on the basis of example embodiments, and on the basis of the drawings, in which:

FIG. 1 is a schematic representation of a modular macro management system according to an embodiment of the invention for parameterizable switchgear;

FIG. 2 is a schematic representation of the structure of a macro;

FIG. 3 is a schematic representation of the selection system according to an embodiment of the invention over a plurality of question levels with various options.

### DETAILED DESCRIPTION OF THE EXAMPLE EMBODIMENTS

The system according to at least one embodiment of the invention is distinguished in that it is connected to an engineering system for parameterizable switchgear and thus, in particular, to the graphical user interface (GUI) thereof. In addition, this system is constructed modular, which means that it contains core modules which fulfill the main purposes of the management system. Furthermore, integrated into the system are various subsystems which support the core modules in fulfilling the tasks thereof. For this purpose, said subsystems make access interfaces available, by means of which the services of the subsystems are offered. The macro management system administers an unlimited number of macros and makes said macros available to the engineering system as needed.

The four core modules are made up of the creation module, the display module, the export module and the import module. The creation module serves for creating or renewing macros. When a macro is created, all the components from which a macro is composed are taken into account. Macros can also be created in different ways by the creation module, either by means of a graphical user interface (by dialogues) or using program means, via interface calls. Newly created macros are incorporated into the system.

The display/catalogue module is responsible for the presentation of all the macros present in the system at the user interface. All the macros displayed are offered to the project engineer for selection and use. In this regard, the module fulfils two functions, firstly the hierarchical representation, secondly user administration. Macros can be stored in main categories and subcategories of arbitrary hierarchy depth. This facilitates the selection, particularly where there is a wide choice of macros. Macros can also be arranged according to various technical or other standpoints. The hierarchy can be stipulated either by the macro itself, that is, by the hierarchy information optionally contained therein, or by the project engineer. The macro management system can be configured so that the project engineer can make changes to the hierarchy or that such changes are blocked.

In the context of user administration, it is provided that the users can be assigned to user groups. The selection of macros displayed can differ depending on the user group. This has the advantage that each user group can be offered a specific selection of macros depending on function (for example, project engineers, testers, commissioning engineers). It is also conceivable for a license model to be attached to the function for an engineering system, in that, depending on the license, a more or less large group of macros is offered.

The import module is capable of integrating existing macros, that is, those created by another project engineer, into the system. This has the advantage that the re-usability of found solutions is further increased, since the solutions are exchanged between users or can be made available centrally to a group of users. The import of macros takes place either via a graphical interface (dialogue), by program means using interface calls, possibly with a batch system, from outside or, alternatively via an automatic or manual update. The target location for the latter function can be a server belonging to the institution itself, or an internet address. In all cases, it is possible to import an unlimited number of macros.

The export module is the counterpart to the import module. Partial solutions that are created can be distributed thereby. The special feature herein, however, is that the export module can be connected to a converter component in order to convert the export data into different formats in order to be able to pass said data to other systems.

In a particularly advantageous embodiment, it is provided that, apart from the core modules, the macro management system has subsystems which support the core modules in solving the problem. The online help subsystem is capable of displaying a multi-sided structured description text. The content of the text is macro-specific. A unique key of the macro is passed to the subsystem. The online help subsystem is controlled from the import module and the display/catalogue module, since the online help can be displayed both in the context of the import process, as well as during actual use. The online help system can either visualize the online help itself for this purpose, or can use a separate module which is either a component of the engineering system or is arranged entirely outside the system. The content of the macro-specific online help is a component part of the documentation data of the macro.

The document display subsystem serves to visualize additional documents, for example, manuals or reference works which are linked to another macro. The fundamental mechanisms correspond to those of the online help. For this purpose, the different formats which are in current use (doc, pdf, rtf, etc.) are supported. The list of formats that are supported can be extended subsequently by installing additional format filters. The documents which are visualized by this subsystem can either be placed physically within the macro, that is, in the documentation data or, alternatively, can be reached via a reference. The document display subsystem is controlled by the import module and the display/catalogue module, since macro-specific documents can be displayed both in the context of the import program and also on actual use.

The short description subsystem is capable of displaying short description texts used for selecting macros. The subsystem supplies a macro-specific short text to the import module and the display/catalogue module, said short text being helpful during the importing or use of macros. Short descriptions are a component of the documentation data of the macro.

The macro management system also has a selection system which serves to assist the user in making a selection suited to the technical problem from a number of macros. The macro selection takes effect on use of a macro and during import thereof.

According to at least one embodiment of the invention, the macros are assembled from various components. These include functional components, interconnections, device parameterizations, documentation data, hierarchy information and selection metadata.

The functional components are functions which are offered by the switchgear and which can be selected at the user interface of the engineering system and can be parameterized in a function plan. Functional components have inputs and/or outputs to enable said components to connect to other functional components. Typical examples of functional components are monitoring components (for example, an emergency stop) or logic components.

Connections are links between inputs and outputs of functional components. The totality of the functional components with links placed therebetween forms the functional plan and the application logic.

A switchgear unit offers a plurality of device parameters, for example, load type, cooling time, threshold values. Functional components are also usually parameterizable, for example, the limit value in counter components. All the parameters constitute the parameterization and are components of a macro.

The documentation data is additional information which support project engineers in the importing of macros, the use thereof and further parameterization.

The hierarchical information serves to arrange the macro in a technological hierarchy. The information includes all the categories and subcategories into which the macro is arranged. The display/catalogue subsystem evaluates this information and assigns the macro into the respective catalogue area, wherein the given categories are renewed when necessary.

The selection metadata constitute the database on which the selection system leads the user to a solution-oriented selection of a macro.

The core of at least one embodiment of the present invention lies in guiding the project engineer, via various question levels and various options in each question level to a restricted final selection of macros. The list of macros offered at the end of the selection process is dependent on the option path the project engineer has followed. The macros in the final selection differ mostly only slightly. The final selection can now be made on the basis of the short description of the macro or a live preview. In the latter case, the macro is temporarily generated in the macro management system and, therefrom, a visualization is generated without integrating the macro into the engineering system. The purpose lies in providing the user with an overview of the structure of the macro.

Optionally, a function test could be carried out at this point. A macro that has been selected in this way is subsequently integrated into the engineering system or instantiated in the function plan, depending on the context in which the selection process is configured. The selection metadata contain all the information required in order to describe precisely an option path which leads exactly to this macro, that is, to describe a series of options to be selected across the question levels. In this process, particular rules are taken into account:
1. A plurality of macros (macro 1, macro 2, macro 3) can describe the same option path. In this case, these macros are offered in the final selection. A finalized selection can then be made with the aid of the live preview or the short description.
2. The number of triplets (including a question level, question in text form, option) is not limited. The number defines the number of question levels of an option path. The number of question levels can be different for different macros.
3. If a macro relates, at a question level, to an already existing question level by giving the same ID, the options at said level are extended by the option described in this macro. If an as yet not existing question level is given, then a new question level is generated therefrom. With all the macros integrated into the macro management system, a hierarchical question/option tree is created.

The live preview serves to support the project engineer in the final selection of the macro. For this purpose, the macro is temporarily and locally instantiated and visualized in the selection subsystem. For visualization, the selection subsystem accesses the engineering system and, in particular, the graphical interface (GUI) thereof and the programming interfaces of the GUI. The advantage of this live preview, that is, of a dynamic visualization generated at the selection time point, in contrast to a static display of an image which could be placed in the macro lies therein that the preview is always matched to the engineering system. If, on a version change, changes are made to the graphic interface specifically for displaying the function plan, the display is automatically adapted for the live preview. The advantage arising from the preceding point lies therein that during the version change described herein, the selection metadata do not need to be changed. In contrast to a static image, the live preview can be scaled without difficulty and without quality loss. The graphical scaling is assumed by the engineering system, through the GUI system thereof. In addition, functions for the preview can be taken over in the selection system. Furthermore, the display can be dynamized. It is imaginable that the selected macro is simulated in advance in order to test the behavior of the macro. This would also simplify the selection of a macro.

The actual realization of the selection system is not specified by embodiments of the invention. The selection metadata in the macros also describe only the questions of the question levels and the options, but not the technical configuration of the system. The following embodiment possibilities are imaginable:
1. A multi-stage dialogue with, in each case, one question level and one option list on one side.
2. A dialogue with, in each case, one register card for one question level. The project engineer is guided over all the register cards in sequence.
3. A dialogue which is not limited in the vertical direction, in which all the question levels, including the options, are displayed.

The essential advantage of the macro management system according to at least one embodiment of the invention lies in the modular construction. The main functionalities are covered by core modules. Possible extensions can be introduced with additional modules. The subsystems which function as service providers for the core modules contribute to a clear overall structure of the macro management system. Only a narrow interface is provided to the engineering system. The macro management system functions largely autonomously. This facilitates the conception and realization of the overall system. The specific structure of the macros is also inventive. The macros contain not only the purely technical content for the project design, but also document data and selection data. It is also advantageous that the totality of the macros defines a hierarchical selection system. No further information needs to be stored at any other site for the selection of macros. A further advantage is the live preview, which takes the place of static images.

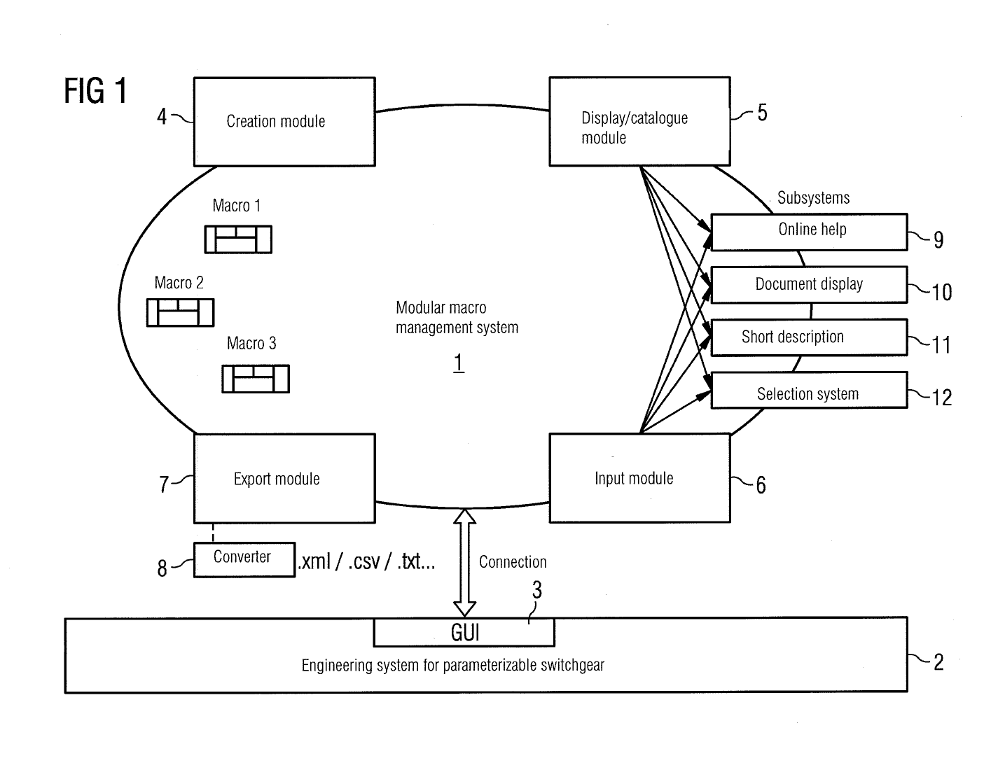

FIG. 1 shows the structure of a modular macro management system for parameterizable switchgear. The modular macro management system 1 according to an embodiment of the invention is distinguished in that said system is connected to an engineering system 2 for parameterizable switchgear and particularly to the graphical user interface (GUI) 3 thereof. The macro management system 1 is constructed modular, that is, the system contains core modules which fulfill the main aims of the management system. Furthermore, a variety of subsystems can be integrated into the system, the subsystems supporting the core modules in fulfilling the purpose thereof. For this purpose, said subsystems make access interfaces available, via which the services of the subsystems are offered.

The macro management system 1 administers an unlimited number of macros and makes the macros available to the engineering system 2 when needed. The four core modules include the creation module 4 which serves to generate macros. During the generation of a macro, all the components from which the macro is made are taken into account. Macros can be generated by the creation module 4 in different ways, either by a graphical user interface or by program means through interface calls. Newly created macros are incorporated into the system 1.

The display/catalogue module 5 is responsible for the presentation at the user interface 3 of all the macros present in the system 1. All the macros displayed are offered to the project engineer for selection and use.

The import module 6 is capable of integrating created macros already present into the system 1. This has the advantage of further increasing the re-usability of the solutions found, since solutions can be exchanged between users or made available centrally to a group of users. The importing of macros takes place either via a graphical user interface, by program segments/modules through interface calls from outside or alternatively, via an automatic or manual update. An institution-internal server or an internet address can be given as the target location for the latter function. In all cases, it is possible to import an unlimited number of macros.

The export module 7 is the counterpart to the import module 6. Partial solutions that have been created can be distributed in this way. The peculiarity herein, however, is that the export module 7 can be connected to a converter component 8 in order to convert the export files into various formats, to be able to pass said data on to other systems.

Subsystems are also shown in FIG. 1. The online help subsystem 9 is able to display a multi-sided structured description text. The content of the text is macro-specific. For this purpose, a unique key is passed to the macro in the subsystem 9. The online help subsystem 9 is controlled from the import module 6 and the display/catalogue module 5, since the online help can be displayed both in the context of the import procedure and also during actual use.

The document display subsystem 10 serves for visualizing additional documents that are linked to a macro. The essential mechanisms correspond to those of the online help system. The different formats that are currently used are supported. The list of formats that is supported can be retrospectively expanded. The short description subsystem 11 is capable of displaying short description texts which are used for macro selection. The subsystem 11 supplies a macro-specific short text to the import module 6 and the display/catalogue module 5, said text being helpful during import or on use of macros.

Short descriptions are a component of the documentation data of the macro.

The selection system 12 serves to help the user to make a selection suitable for the technical problem from a number of macros. The macro selection takes effect during the use of a macro and on importing macros.

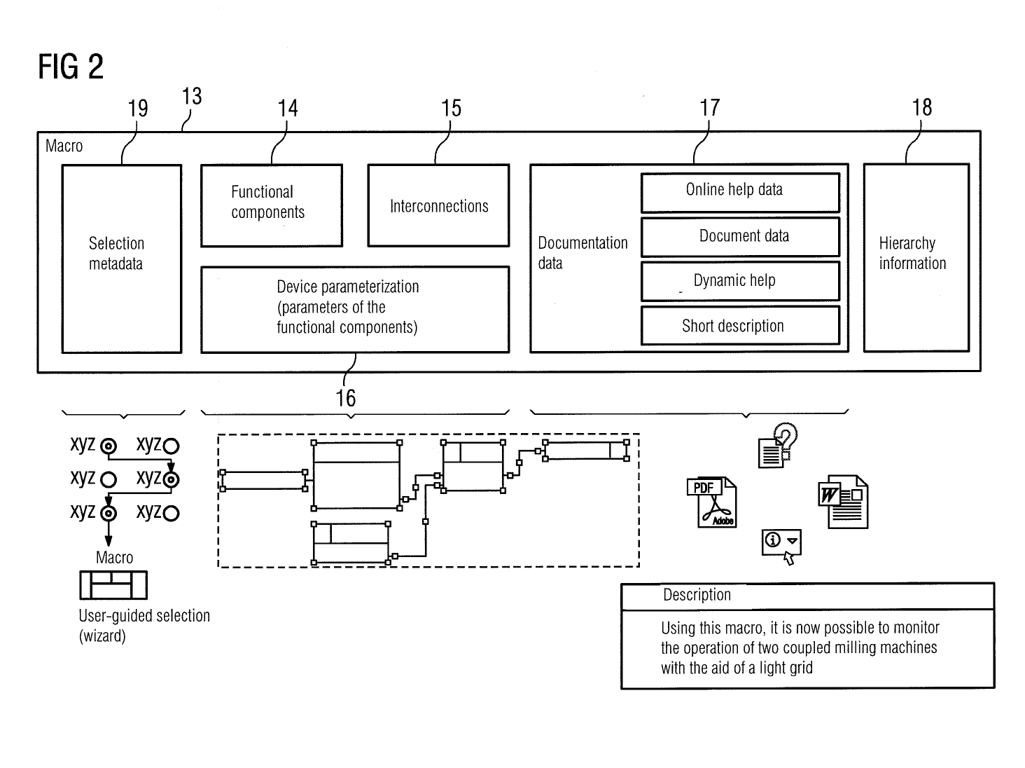

FIG. 2 shows the composition of a macro 13. The macro 13 according to an embodiment of the invention has functional components 14, interconnections 15, device parameterizations 16, documentation data 17, hierarchy information 18 and selection metadata 19. The functional components 14 are functions that are offered by the switchgear unit and which can be selected at the user interface 3 of the engineering system 2 and parameterized in a function plan. The functional components 14 have inputs and/or outputs in order to be able to interconnect to other functional components. Typical examples of functional components are monitoring components or logic components.

The interconnections 15 are connections between inputs and outputs of functional components 14. The totality of the functional components 14 with the connections therebetween constitute the function plan and the application logic. The device parameterization 16 involves a switchgear unit offering a plurality of device parameters. The functional components 14 are also, as a rule, parameterizable. All said parameters constitute the device parameterization 16 and are components of a macro 13.

The documentation data 17 consist of additional information that supports the project engineer in the importing of macros, the use thereof and the further parameterization.

The hierarchy information 18 serves to allocate the macro 13 in a technological hierarchy. The information consists of all the categories and sub-categories into which the macro 13 is allocated. The display/catalogue subsystem 5 evaluates said information and allocates the macro 13 to the respective catalogue domain, wherein if needed, the categories given are generated anew.

The selection metadata 19 represent the database in which the selection system leads the user to a solution-oriented selection of a macro 13.

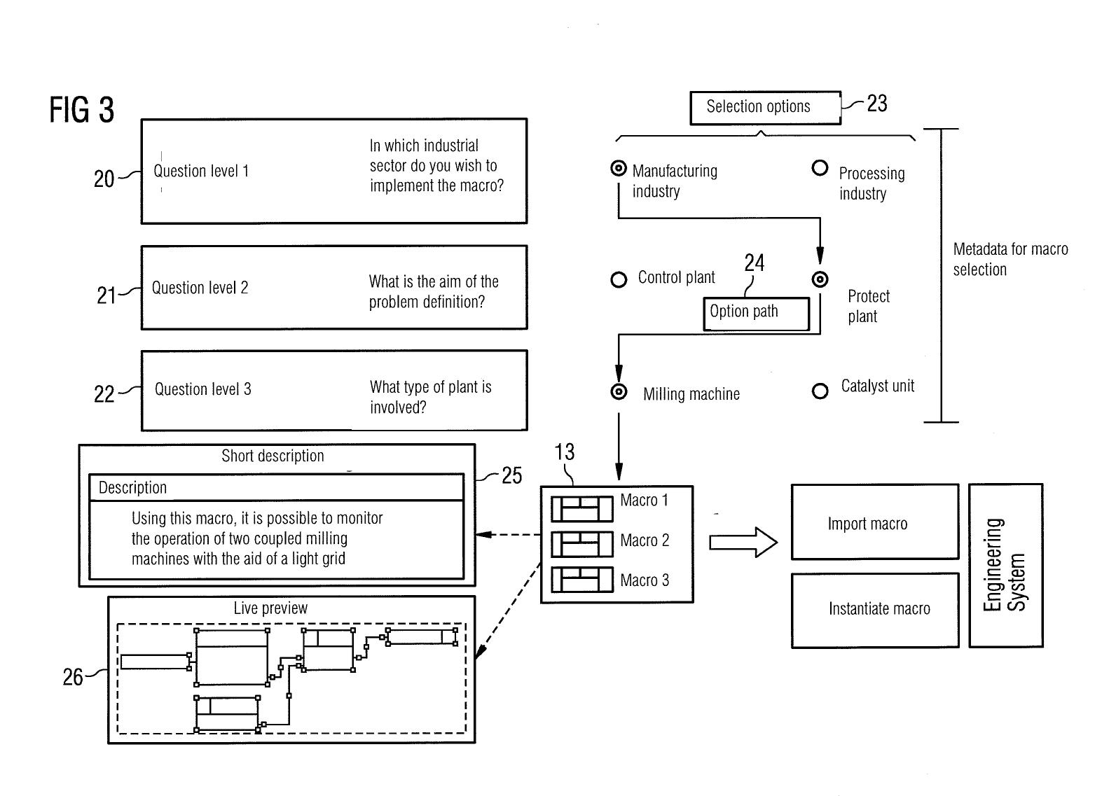

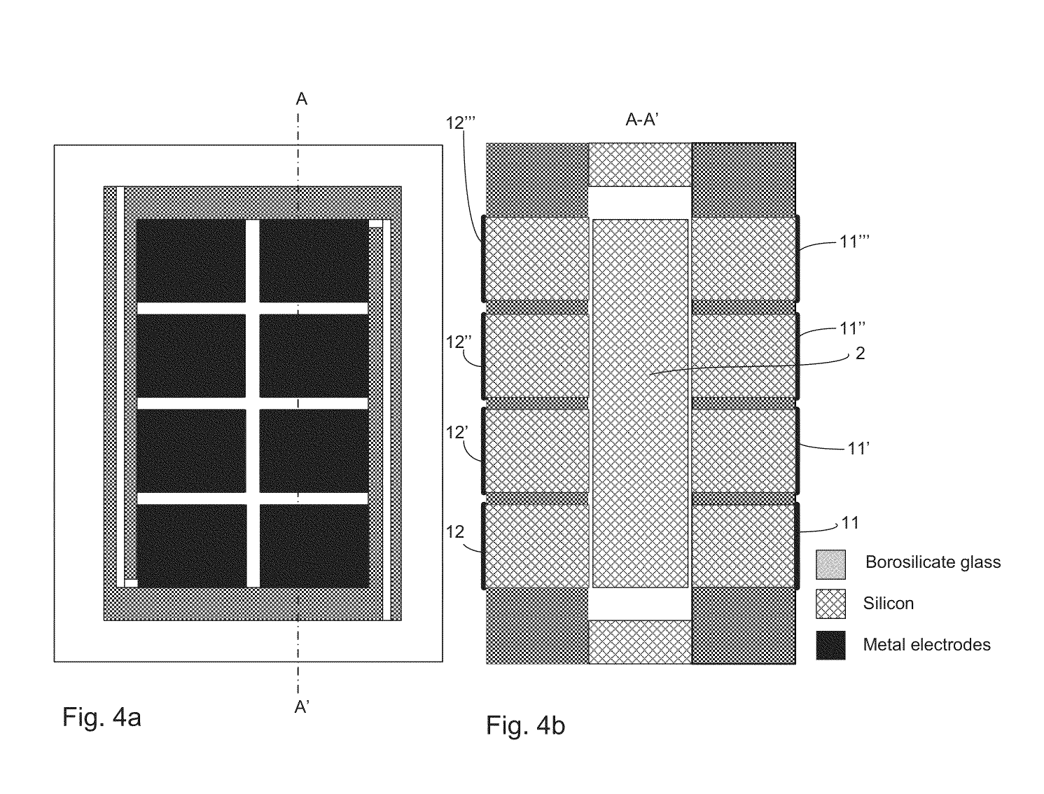

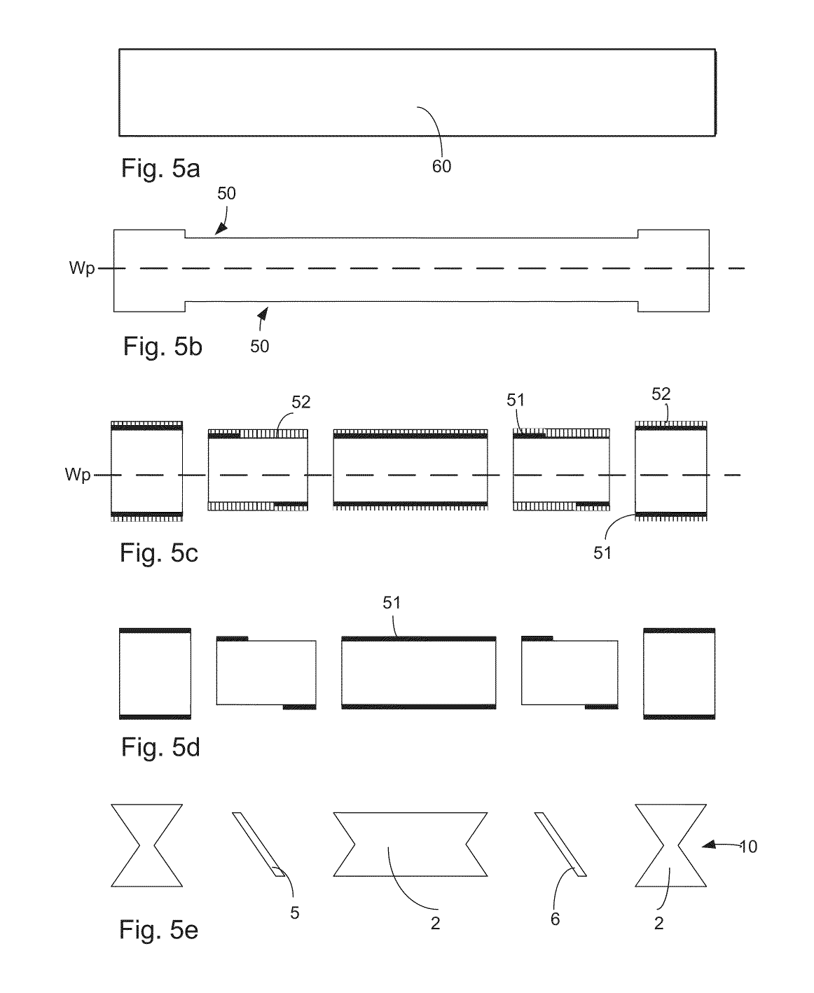

FIG. 3 shows the selection system according to an embodiment of the invention over a plurality of question levels with various options. The core of an embodiment of the invention lies in guiding the project engineer via a plurality of question levels with various options in each question level, to a restricted final selection of macros 13. The individual question levels 20, 21, 22 contain questions such as, for example, “In which industrial sector do you wish to implement the macro?”; “What is the aim of the problem definition?; or “What type of plant is involved?”. By way of the respective selection options 23 which could be, for example, for question 1: “Manufacturing industry” or “Processing industry”, to question 2: “Controlling the plant” or “Protecting the plant” and, to question 3: “Milling machine” or “Catalyst unit”, the project engineer arrives at an option path 24 which leads at the end of the selection process, depending on the option path 24, to a list of the macros 13 offered. Herein, the macros 13 in the final selection usually differ only slightly. The final selection can now be made, based on the short description 25 of the macro or a live preview 26. In the latter case of a live preview 26, the macro 13 is temporarily generated in the macro management system 1 and a visualization is created therefrom without the macro 13 itself being integrated into the engineering system 2. The purpose lies in giving the user an overview of the structure of the macro 13. Optionally, a function test can be offered already here. A macro 13 selected in this way is subsequently integrated into the engineering system 2 or instantiated in the function plan, depending on the context in which the selection process is started. The selection metadata 19 of a macro 13 therefore contain all the data required in order to describe precisely an option path 24 which leads to exactly this one macro 13. In this process, the following rules are observed:
1. A plurality of macros can describe the same option path 24. In this case, these macros 13 are offered in the final selection. A final selection can be made with the aid of the live preview 26 or the short description 25.
2. The number of triplets (consisting of question level, question in text form, option) is not limited. The number defines the number of question levels of an option path 24. The number of question levels can be different for different macros 13.
3. If a macro 13 relates, at a question level, to an already existing question level, the options at said level are extended by the options described in said macro 13. If an as yet not existing question level is given, then a new question level is generated therefrom. Overall, a hierarchical question/option tree is generated by all the macros integrated into the macro management system 1.

The essential advantage of the macro management system according to an embodiment of the invention lies in the modular construction thereof. The main functionalities are covered in the core modules. Possible extensions can be introduced by additional modules. The subsystems which function as service providers for the core modules contribute to a clear overall structure of the macro management system. There is only a narrow interface to the engineering system. The macro management system functions essentially autonomously. This facilitates the conception and realization of the overall system. The specific structure of the macros is also inventive. The macros contain not only the purely project-related content, but also documentation data and selection data. It is also advantageous that the totality of the macros describes a hierarchical selection system. No further information must be placed elsewhere for the selection of macros. A further advantage is the live preview which takes the place of static images.

1. A macro management system for an engineering system for parameterizing switchgear, comprising at least the following core modules:
a creation module, designed to create macros;
a display/catalogue module, designed for the presentation of all the macros present in the system;
an import module, designed to integrate already existing macros into the system; and
an export module, designed to distribute macros which have already been created,
the management system being connected to a graphical user interface of the engineering system, wherein a project engineer is guidable, with various options, to a restricted final selection of macros via a plurality of question levels.

2. The macro management system of claim 1, further comprising subsystems which support the core modules in fulfilling tasks.

3. The macro management system of claim 2, wherein the subsystems include an online help subsystem, configured to display a multi-sided structured description text.

4. The macro management system of claim 2, wherein the subsystems include a document display subsystem, configured to visualize additional documents linked to a macro.

5. The macro management system of claim 2, wherein the subsystems include a short description subsystem, configured to display short description texts.

6. The macro management system of claim 2, wherein the subsystems include a selection system, configured to allow the project engineer to make a selection that is suitable for a technical problem from a number of macros.

7. The macro management system of claim 1, wherein a macro comprises functional components which contain functions offered by the switchgear unit.

8. The macro management system of claim 2, wherein a macro comprises functional components which contain functions offered by the switchgear unit.

9. The macro management system of claim 3, wherein a macro comprises functional components which contain functions offered by the switchgear unit.

10. The macro management system of claim 4, wherein a macro comprises functional components which contain functions offered by the switchgear unit.

11. The macro management system of claim 5, wherein a macro comprises functional components which contain functions offered by the switchgear unit.

12. The macro management system of claim 6, wherein a macro comprises functional components which contain functions offered by the switchgear unit.
